(19) United States
(12) Patent Application Publication
(10) Pub. No.: US 2014/0047758 A1
(43) Pub. Date: Feb. 20, 2014

(54) FISHING POLE MOUNT APPARATUS

(71) Applicant: Mark Ramon Ciciulla, Melbourne, FL (US)

(72) Inventor: Mark Ramon Ciciulla, Melbourne, FL (US)

(21) Appl. No.: 13/971,816

(22) Filed: Aug. 20, 2013

Related U.S. Application Data
(60) Provisional application No. 61/684,847, filed on Aug. 20, 2012.

(51) Int. Cl. A01K 97/10; A01K 99/00

(52) U.S. Cl. CPC A01K 97/10; A01K 99/00
USPC 43/21.2

(57) ABSTRACT

An adjustable fishing pole holder system which is adaptable to temporarily but securely mount on a variety of receiving structures is described. The adjustable fishing pole holder system of the invention may be mounted on horizontal structures of various cross-sections such as the hand rails of bridges, catwalks, jetties or similar structures. The adjustable fishing pole holder system may also be mounted on vertical or angled structures such as pilings and the like. The adjustable fishing pole holder of the invention is attached to a receiving structure by at least one adjustable strap which may further comprise a ratcheting strapped tightener. A fishing hook eye retainer is provided which allows a fisherman to securely attach a hooked line in order to prevent snag injuries. The invention may also be used to hold other devices such as flag poles or other pole-like structures.

### CROSS REFERENCE TO RELATED APPLICATIONS

This U.S. non provisional patent application claims the benefit of U.S. Non provisional patent application Ser. No. 61/684,847 which was filed in the United States Patent and Trademark Office (USPTO) on Aug. 20, 2012, and which is incorporated herein in its entirety by reference.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention relates generally to the field of devices utilized to mount pole-like elements to other structures. Such pole-like elements may be, for example, fishing poles, flagpoles, or other similar pole-like elements. It is often desired to mount such pole like structures to more permanently affixed structures in order to secure them for use, display, or other purposes. Typical examples of such uses are to hold a fishing pole for use during fishing or for display, to hold a flag pole for display of a flag, and other similar uses. More specifically, the apparatus of the invention is directed to an adjustable mounting apparatus that is adjustable on multiple axes, is adjustable as to the angle at which the pole is held, is adaptable to various shapes and sizes of structures upon which the apparatus is mounted, is easy to deploy and utilize and enables the mounting of a pole element at virtually any orientation the user desires, on virtually any structure.

2. Background Art

There are known in the art certain fishing pole mounting apparatuses which are designed to mount a fishing pole onto a more permanently affixed structure. Typically, these devices incorporate complicated brackets which require hardware such as screws, nuts, and the like to secure to the permanently affixed structure. These legacy devices are typically designed to affix onto a flat horizontal surface such as the gunwale or transom of a boat and are not generally adaptable for use on structures such as the handrails of bridges, jetties or catwalks; nor are they adaptable for use on vertical structures such as pilings or hand railings of docks and similar structures. This means that the fisherman who is fishing from, for example, a bridge, jetty or catwalk, must hold the fishing pole at all times. This means that his hand are not available for other purposes such as cutting and handling bait, receiving phone calls, or any other activity while the fishing pole is in use.

As an example of background art, U.S. Pat. No. 3,973,346 to Mason describes a fishing pole holder that affixes to a horizontal surface of a boat which is adapted to receive a cylindrical rod affixed to the bottom of the fishing pole holder. While this fishing pole holder will hold a fishing pole onto the transom of a boat, it is not adaptable to various structures that are vertically oriented, nor can it mount to structures such as hand railings of bridges or other similar structure.

Another example of a fishing pole holder of the prior art is U.S. Pat. No. 2,481,272 to Williams. Williams describes a fishing pole holder that affixes to a horizontal surface of the boat, for instance the transom, to hold a fishing pole in position for trolling. While this fishing pole holder will hold a fishing pole, it is not adaptable to various structures that are vertically oriented, nor can it mount to structures such as a hand railing of bridges or other similar structure, nor is it adapted to operate on multiple axes.

Still other fishing pole holders are described in U.S. Pat. No. 2,427,602 to Hanke, U.S. Pat. No. 2,427,602 to Nelson, U.S. Pat. No. to Fahringer, Sr. and U.S. Pat. No. 3,204,899 to Danielewicz et al. None of these devices are adaptable to various structures that are vertically oriented, nor can they mount to structures such as hand railings of bridges, catwalks jetties or other similar structures.

Oftentimes fishermen find themselves fishing from structures such as bridges, catwalks, or boats; or wading near pilings, jetties, and similar structures that are adjacent to or above the water. It is desired that there be a means for mounting a fishing pole onto such structures while the fishermen are waiting for fish to bite, or while the fishermen are attending to other tasks such as baiting a hook, cleaning fish or performing other chores. It is a shortcoming of the fishing pole holders of the prior art, therefore, that a means for mounting a fishing pole onto a structure which is adaptable to various types of structures, various cross-sections of structures, able to be mounted in either a horizontal or vertical position, and allow for the ability to adjust the angle of the fishing pole as it is held in the fishing pole holder does not exist. The devices of the prior art are not able to perform these functions.

What is needed in the art therefore is an adaptable fishing pole holder that is adaptable as described above and is easy to deploy and use. The present invention overcomes the shortcomings of the prior art in a compact, fully adjustable, economical and easy to use manner.

### BRIEF SUMMARY OF THE INVENTION

The present invention comprises a system and/or method that have one or more of the following features and/or steps, which alone or in any combination may comprise patentable subject matter.

In accordance with one embodiment of the present invention, the invention is directed to an adaptable, adjustable fishing pole holder system that is usable on various types of structures and in various orientations. The fishing pole holder system, in a preferred embodiment, comprises a base mounting block that is adapted to receive a fishing pole holder, which itself may be adapted to receive and hold a fishing pole or similar structure such as a flag. The invention may comprise an adjustable fishing pole holder with the ability to be adjusted to hold a fishing pole or other rod at a variety of angles, and a base mounting block which may be adapted to receive the fishing pole holder, and may also be adapted to be strapped on a receiving structure by one or more adjustable straps. The invention may also comprise the base mounting block of the invention, upon which alternative fishing pole holders may be attached at the user's determination. In a preferred embodiment, the fishing pole holder element of the invention may be, for example, of the type known as No. 230 Power Lock with Combination Side/Deck Mount produced by Scotty Fishing and Outdoor Products of Sidney, British Columbia, Canada. The fishing pole holder system of the invention is adapted to mount to horizontal, vertical, or angled structures of any cross-sectional shape by virtue of the unique and novel features of the base mounting block of the invention. For instance, the fishing pole holder system of the invention may be strapped onto the handrail of a jetty, bridge or other structure; alternatively, it may be strapped onto a vertical piling such as used in marinas, boat docks and the like. While various receiving structures such as bridge hand railings, pilings, and other structures are described in this patent application, it is to be understood that the receiving structure is not to be construed as a limitation on the scope of the present invention, and that the invention is adapted to be mounted on virtually any receiving structure.

A preferred embodiment of the system of the invention utilizes one or more straps to secure the base mounting block of the fishing pole holder system of the invention to a receiving structure. The straps of the invention are adjusted for a snug fit on the receiving structure in order to secure base mounting block of the fishing pole holder system in place on the receiving structure. Once in place, the fishing pole holder system of the invention may be utilized to store a fishing pole, to hold a fishing pole at any given angle while a baited hook has been deployed, to hold a fishing pole in place while fishermen performs operations such as attaching hooks, sinkers, bobbers, bait, fishing lures or the like to a fishing line, and other similar uses. A fisherman may utilize a plurality of the fishing pole holder systems of the invention to hold any number of fishing rods, allowing the fisherman to utilize his or her hands to perform other operations and also allowing the setting of multiple fishing lines thereby increasing the probability of catching fish.

An alternate embodiment of the base mounting block of the fishing pole holder system of the invention further comprises a removable cutting board which may itself further comprise a hinged extendable cutting board to increase the cutting board surface available to the fishermen. In this alternate embodiment, the cutting board may be held in place by the use of one or more spring-loaded plungers or other retainer device which allows the cutting board to be removed when not in use. The removable cutting board provides a stable horizontal surface which may be used to cut bait or support any other operation the fisherman desires.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments or some of the alternate embodiments of the invention and are not to be construed as limiting the invention. In the drawings:

FIG. 1 depicts a perspective view of a preferred embodiment of the fishing pole holder system of the invention mounted onto a horizontal receiving structure such as a bridge or catwalk handrail using the bottom surface of the base mounting block to securely contact the horizontal receiving structure.

FIG. 2 depicts a perspective view of a preferred embodiment of the fishing pole holder and its base, with the other elements of the fishing pole holder system not shown for clarity.

FIG. 3 depicts a perspective view of a preferred embodiment of the fishing pole holder system of the invention mounted onto a vertical receiving structure which may be found, for example, on a bridge, catwalk, or piling.

FIG. 4 depicts a perspective view of a preferred embodiment of the fishing pole holder system of the invention mounted onto a small diameter receiving structure using the v-groove of the base mounting block to securely contact the small diameter receiving structure.

FIG. 5 depicts a perspective view of a preferred embodiment of the fishing pole holder system of the invention mounted onto a horizontal receiving structure and in which a fishing rod has been placed in the fishing pole holder, and the fishing line hook is retained by fish hook retaining eye in the front surface of the base mounting block.

FIG. 6 depicts perspective view of an alternate embodiment of the fishing pole holder system of the invention which shows the removable cutting board and hinged cutting board extension, in which the hinged cutting board extension is shown in the closed position and first cutting board arm and second cutting board are in alignment with the first and second slots of the base mounting block, and the cutting board and hinged cutting board extension are being motivated toward the base mounting block.

FIG. 7 depicts a perspective view of an alternate embodiment of the fishing pole holder system of the invention showing a perspective view of the removable cutting board and hinged cutting board extension in which the hinged cutting board extension is shown opening on its hinge.

FIG. 8 depicts a cross section view of a preferred embodiment of the invention mounted on to a tubular structure of circular cross section using the arcurate bottom surface of the base mounting block to contact the structure.

FIG. 9 depicts a cross section view of a preferred embodiment of the invention mounted on to a tubular structure of circular cross section using the v-groove in the rear surface of the base mounting block to contact the structure.

FIG. 10 depicts a cross section view of an alternate embodiment of the invention in which spring loaded plungers are utilized to retain the first cutting board arm in the first slot of the base mounting block, and to retain the second cutting board arm in the second slot of the base mounting block.

FIG. 11a depicts an isometric projection of the front surface of a preferred embodiment of the base mounting block of the invention.

FIG. 11b depicts an isometric projection of the bottom surface of a preferred embodiment of the base mounting block of the invention.

FIG. 11c depicts an isometric projection of the top surface of a preferred embodiment of the base mounting block of the invention.

FIG. 11d depicts an isometric projection of the right side surface of a preferred embodiment of the base mounting block of the invention.

FIG. 11e depicts an isometric projection of the left side surface of a preferred embodiment of the base mounting block of the invention.

FIG. 12 depicts a rear surface view of a preferred embodiment of the invention.

FIG. 13 depicts a cross section cutout view of a preferred embodiment of the invention in which a fishing pole holder is attached to a top surface of the base mounting block of the invention using threaded fasteners in counterbored holes.

FIG. 14 depicts an alternate embodiment of the invention, showing a cutting board mounted on onto the base mounting block by the sliding engagement of the first cutting board arm with the first slot in the base mounting block, and the sliding engagement of the second cutting board arm in the second slot of the base mounting block of the invention.

### DETAILED DESCRIPTION OF THE INVENTION

The following documentation provides a detailed description of the invention.

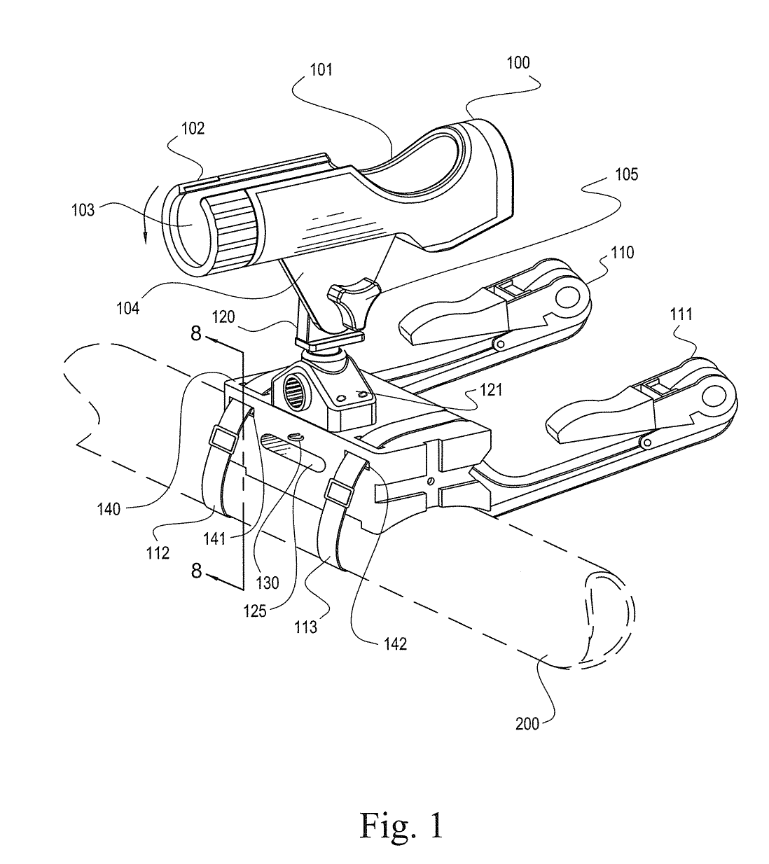

Referring now to FIG. 1, a perspective of the fishing pole holder system of the invention is shown, in which the fishing pole holder system is mounted onto a receiving structure 200 which may be, for instance, the handrail of a bridge, catwalk, or other similar structure near the water. While receiving structure 200 is shown as being circular in cross-section, the fishing pole holder system of the invention is adapted to mount onto any cross-sectional shape such as flat, rectangular, elliptical, square, or any other cross-sectional shape.

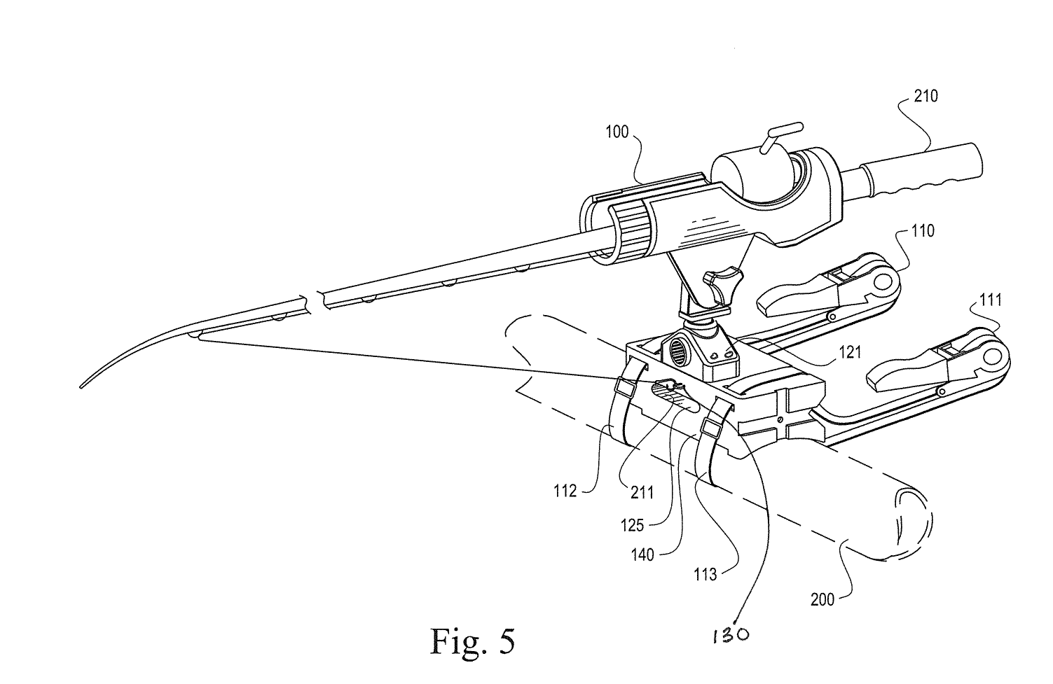

A base mounting block 140 is preferably adapted to receive a first strap 112 and a second strap 113 through a first receiving slot 141 and a second receiving slot 142, respectively. The first receiving slot 141 and the second receiving slot 142 each provide two pathways for straps 112 and 113, respectively. The paths through receiving slots 141 and 142 allow the straps to pass up, through and over base mounting block 140 as shown. Alternatively, first receiving slot 141 and second receiving slot 142 provide a pathway traversing through base mounting block 140 such that straps 112 and 113 may pass entirely through base mounting block 140, exiting from the rear of base mounting block 140 (not shown in FIG. 1). The exiting openings of slots 141 and 142, located on the rear face of base mounting block 140, are depicted further in FIG. 5. Although two straps are shown, only one strap may be utilized, or any number of straps may be utilized. Receiving slots 141 and 142 may be slots as depicted in FIG. 1, or may simply be indentations, or chamfers, in receiving block 140 adapted to receive first strap 112 and second strap 113. Alternatively, no slots or indentations may be used such that first strap 112 and second strap 113 simply strap around base mounting block 140. The straps are tightened onto the receiving structure 200 by use of strap tighteners 110 and 111. First strap tightener 110 and second strap tightener 111 may be any type of strap tightener known in the art such as, for instance, ratcheting strap tighteners, cam action strap tighteners, or any other strap tightener known in the art which is suitable for cinching a strap down onto a receiving structure such as receiving structure 200. The particular type of strap tightener utilized is not to be construed as a limitation of the invention. Base mounting block 140 may be fabricated from plastic, metal, wood, or any material known in the mechanical arts for structural uses as would be understood by a person of ordinary skill in the art.

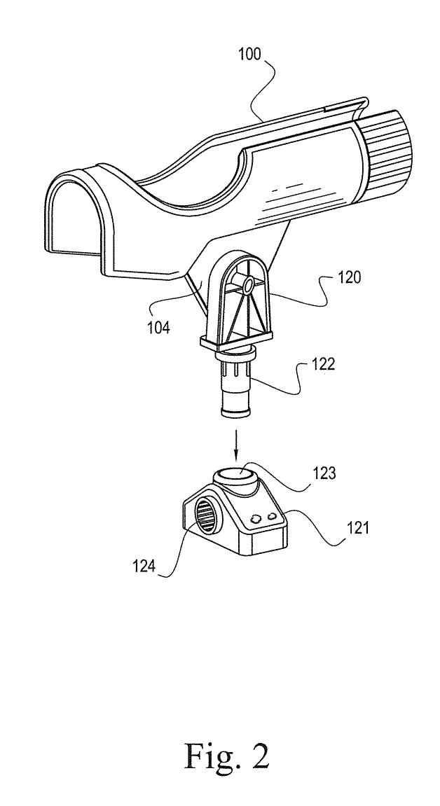

Still referring to FIG. 1, fishing pole holder mount 121 may be affixed to base mounting block 140 by any means that in the art such as, for example and not by way of limitation, threaded fasteners, welding, chemical bonding, molding, press fit or the like. The method of attaching fishing pole holder mount 121 to base mounting block 140 is not to be construed as a limitation of the invention. An alternate embodiment of the fishing pole holder system of the invention comprises fishing pole holder mount 121 and base mounting block 140 fabricated as a single piece using techniques such as casting, molding, machining, hand working, or the like. Fishing pole holder mount 121 may further comprise at least one receiving orifice 123 as depicted in FIG. 2 (not shown in FIG. 1). A preferred embodiment of the fishing pole holder system of the invention comprises a fishing pole holder mount 121 that further comprises two orthogonally oriented receiving orifices 123 and 124 as shown in FIG. 2.

Still referring to FIG. 1, retaining eye 130, discussed further below, is securely attached to base mounting block 140 by threaded engagement or any other means known in the art. Furthermore, opening 125, creating a passageway through base mounting block 140, located below retaining eye 130 as shown in FIG. 1, is usable to provide alternate means of mounting the fishing pole holder of the invention, for instance using a single mounting strap to secure the fishing pole holder to a horizontal, vertical or other structure.

Still referring to FIG. 1, opening 125 extends through base mounting block 140 to provide an alternative means for passing a strap through the base mounting block in order to attach the invention to various structures. This may be done as an alternative to using straps 112 and 113. The use of a strap in conjunction with opening 125 is an alternate embodiment of the invention that greatly increases the adaptability of the invention to certain structures, for example those structures which may not lend themselves easily to use of straps 112 and 113.

Referring now to FIG. 2, a fishing pole holder 100 that is adapted to attach to mount to base mounting block 140 (not shown in FIG. 2) is depicted. It is shown that fishing pole holder mount 121 is adapted to receive cylindrical mount 122 which is affixed to fishing pole holder mount attachment flange 120. Cylindrical mount 122 may, in a preferred embodiment, further comprise splines which interlock with splines incorporated into receiving orifice 123, and also optional receiving orifice 124, allowing the fishing pole holder to be used in an orthogonal or angled position and still allow for secure adjustability of the fishing pole to a desired angle. The use of splines is preferred in order to prevent fishing reel cradle 101 from spinning after being mounted into fishing pole holder mount 121. Likewise, receiving orifice 124 may also be splined in a preferred embodiment so that when it is desired to utilize receiving orifice 124, fishing reel cradle 101 does not spin when cylindrical mount 122 is inserted into optional receiving orifice 124. Still referring to FIG. 2, fishing reel cradle 101 may be supported by fishing pole holder attachment flange 104 which further comprises a through hole. The through hole is adapted to provide a clearance hole for a threaded rod which is an element of fishing pole angular locking element 105 (not shown in FIG. 2 but shown in FIG. 1. In a preferred embodiment, the threaded rod extends through the through hole in fishing pole holder attachment flange 104 and is accepted by a female threaded element in fishing pole holder mount attachment flange 120. By loosening or tightening fishing pole angular locking element 105 a desired pressure may be applied between fishing pole holder attachment flange 104 and fishing pole holder mount attachment flange 120. If a fisherman desires to adjust the angle of fishing pole holder 100, fishing pole angular locking element 105 is loosened and fishing pole holder 100 is rotated into the desired position. After fishing reel cradle 101 is rotated into the desired position, fishing pole angular locking element 105 is tightened thereby causing fishing reel cradle 101 to be held firmly in place. This method of adjusting the angle of fishing reel cradle 101 applies to each orientation in which the fishing pole holder system of the invention is utilized.

Referring again to FIG. 1, fishing pole holder 100 is adapted to receive a fishing pole or any other similar structure through cylindrical fishing pole receiver 103. The fishing pole is inserted butt end first into cylindrical fishing pole receiver 103 and slid into the cylindrical opening of the fishing pole holder until such time as the reel comes to rest in fishing real cradle 101. Fishing pole holder 100 may further comprise a rotating fishing pole lock 102 which may be used to secure the fishing pole into place. Rotating fishing pole lock 102 may further comprise a threaded interface to fishing pole holder 100, or may comprise a sequential series of resistance features or ratchet features such that fishing pole lock 102 does not become unlocked during use. Thus, in this manner, a fishing pole may be inserted into the fishing pole holder system of the invention and locked into place so that the fisherman may leave the pole unattended without fear that the fishing pole will be dragged into the water by a large fish, or fall out of the holder on its own.

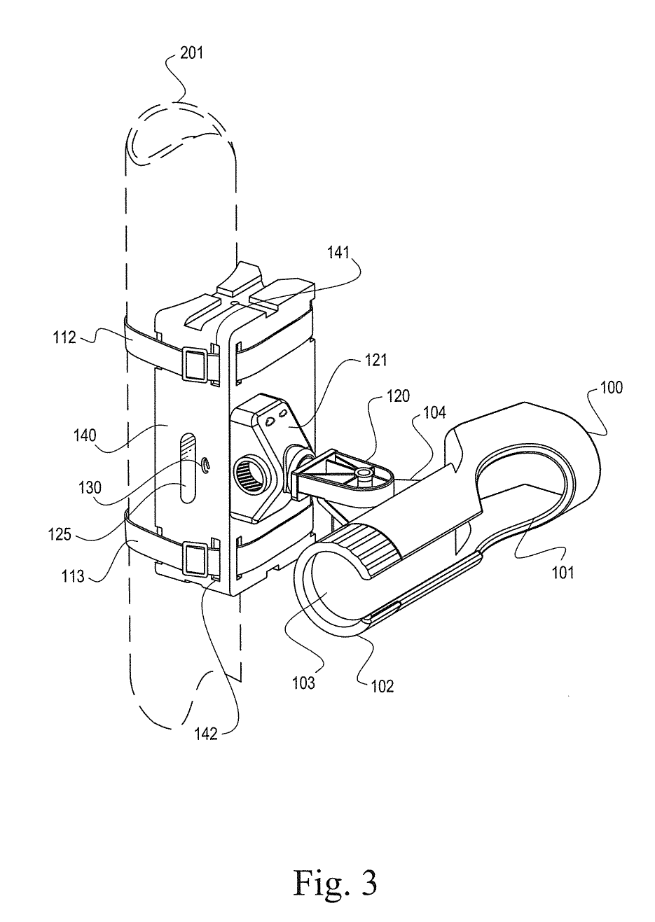

Referring now to FIG. 3, a preferred embodiment of the fishing pole holder of the invention is shown affixed to a vertical receiving structure 201. In this orientation first strap 112 and second strap 113 are utilized to affix the fishing pole holder system to vertical receiving structure 201 in similar fashion as is shown in FIG. 1. It can readily be seen that fishing pole holder 100 is now held in a horizontal position and maybe rotated by loosening or tightening fishing pole angular locking element 105. As discussed above in relation to FIG. 2, in a preferred embodiment of the invention, receiving orifice 123 (not called out in FIG. 3 but depicted and called out in FIG. 2) may further comprise splines, and cylindrical mount 122 (not called out in FIG. 3 but depicted and called out in FIG. 2) further comprises matching splines. When cylindrical mount 122 is inserted into receiving orifice 123, the splines interlock to hold the fishing pole holder system of the invention securely in place, not allowing rotation once cylindrical mount 122 is inserted into receiving orifice 123. If however the fisherman desires to adjust the vertical angle of fishing pole holder 100, this may be accomplished by removing, rotating, and reinserting cylindrical mount 122 in any splined position as allowed by the splines in cylindrical mount 122 as engaged into the splines of receiving orifice 123. This angular adjustment may be performed in any orientation in which the fishing pole holder system of the invention is utilized. Also shown for reference in FIG. 3 are first receiving slot 141, second receiving slot 142, fishing pole receiver 103, fishing pole lock 102, fishing reel cradle 101, fishing pole holder attachment flange 104, fishing pole holder mount attachment flange 120, fishing pole holder mount 121, base mounting block 140, opening 125 and retaining eye 130.

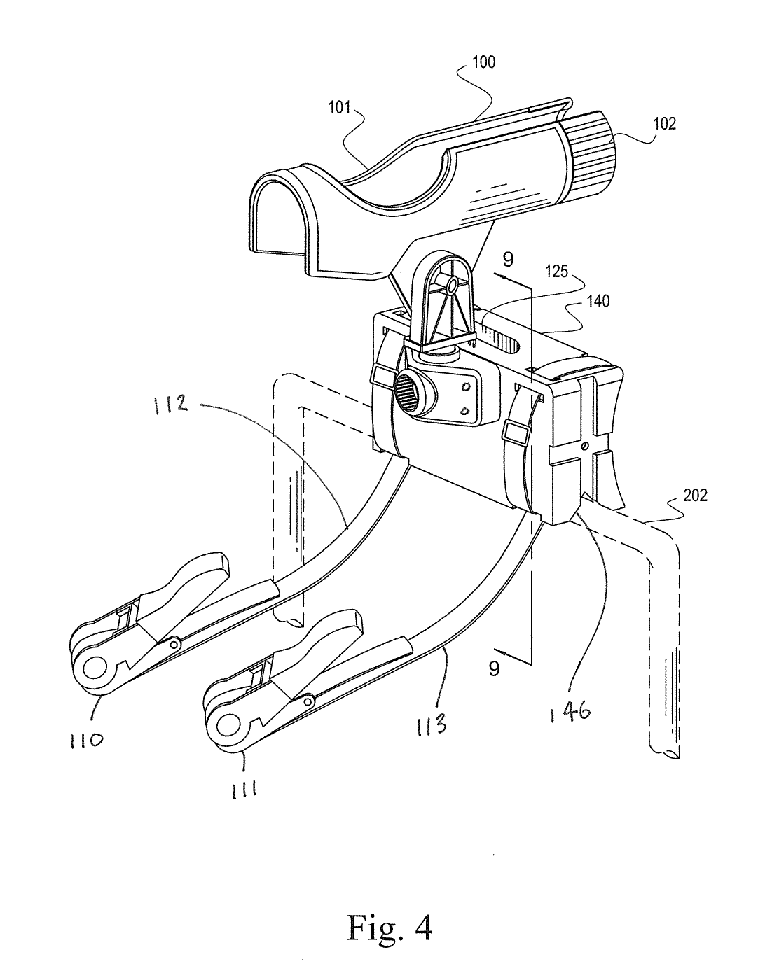

Referring now to FIG. 4, a perspective view of preferred embodiment of the fishing pole holder of the invention is shown mounted onto a small diameter handrail or similar horizontal receiving structure 202. In this orientation, base mounting block 140 has been rotated such that v-groove 146 rests upon the small diameter receiving structure 202. First strap 112 and second strap 113 are utilized to affix the base mounting block onto horizontal receiving structure 202 by operation of tightening first strap tightener 110 and second strap tightener 111. The method of adjusting the angle of fishing pole holder 100 by loosening or tightening fishing pole angular locking element 105 (not shown in FIG. 4 but shown in FIG. 1) is performed in similar fashion as is used in other orientations described herein. Also depicted in FIG. 4 are fishing reel cradle 101, fishing pole lock 102 and opening 125, which provides a passageway through base mounting block 140 to allow a strap to pass through for securing to receiving structures of various configurations in alternate positions.

Referring now to FIG. 5, a perspective of the fishing pole holder system of the invention is shown in which a fishing rod 210 has been inserted into fishing reel cradle 101. This is one of many uses of the apparatus of the invention. Fishing hook 211 has been threaded through fishing at retaining eye 130, where it is securely retained allowing fishermen to perform other tasks such as cutting bait. The fishing pole holder system of the invention therefore provides a stable apparatus upon which a fisherman may insert a fishing rod and secure a fishing hook which may prevent injury due to the sharp points of the fishing hook that may be free to float or fly in the wind. Fishing hook injuries are a significant component of all fishing injuries: the incorporation of the optional retaining eye 130 may prevent such injury if used to hold the fish hook in place so as to prevent it from swinging freely on the end of a fishing line. Fishing pole holder mount 121 is attached to a top surface of base mounting block 140 by any means known in the art, including but not limited to threaded fasteners. First strap 112 and second strap 113 are tightened by operation of first strap tightener 112 and second strap tightener 113 such that base mounting block 140 is securely held in place on receiving structure 200. Opening 125, which provides a passageway through base mounting block 140 to allow a strap to pass through for securing to receiving structures of various configurations in alternate positions, is also depicted.

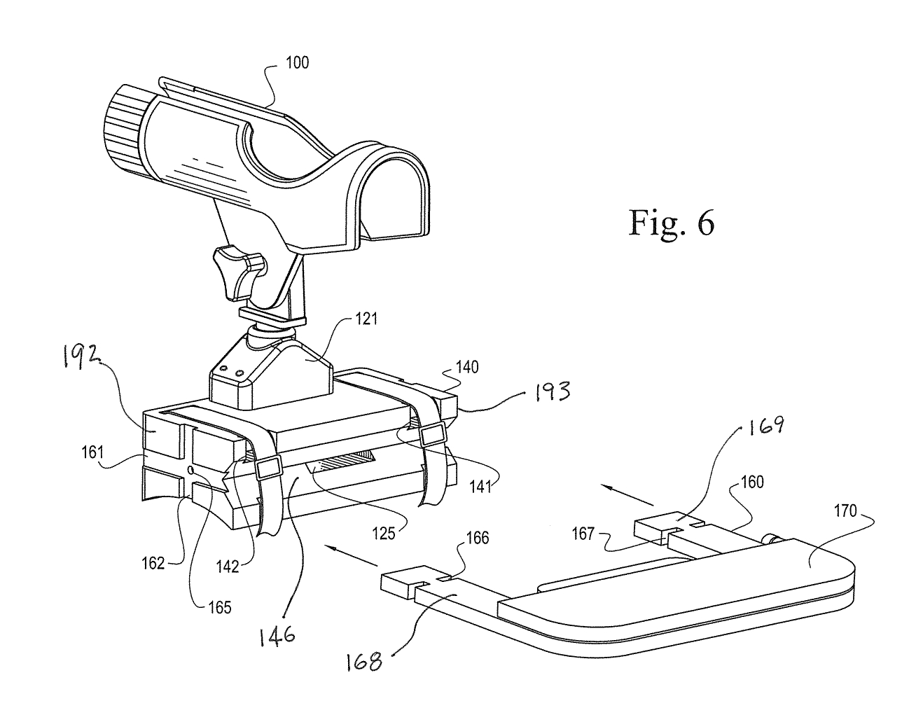

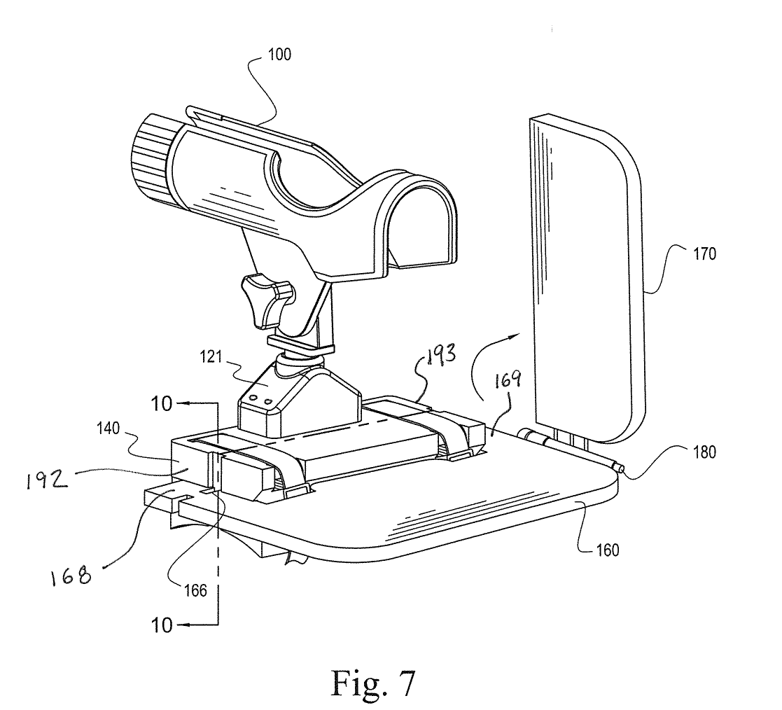

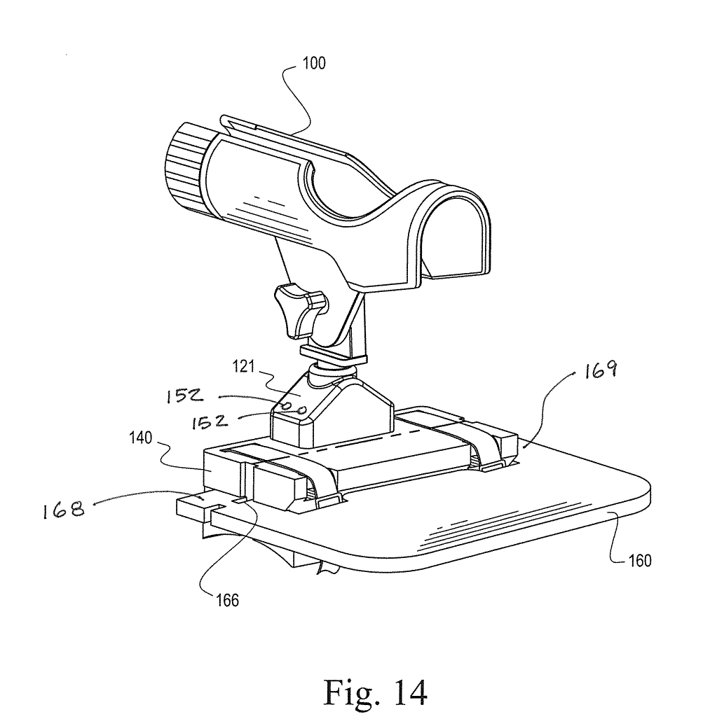

Referring now to FIG. 6, an alternate embodiment of the fishing pole holder system of the invention is shown in which optional cutting board 160 and optional hinged cutting board extension 170 are depicted. Cutting board 160 may comprise a first cutting board arm 168 and a second cutting board arm 169 that may slide into first slot 161 and second slot 163 respectively (not shown in FIG. 6 but shown in FIGS. 10 and 14) which are located on either side of base mounting block 140: first slot 161 is located on base mounting block 140 right side surface 192 and second slot is located on base mounting block left side surface 193. Slots 161 and 163 have a width and a depth. The widths of slots 161 and 163 are dimensioned to accept the thickness of the material used to fabricate cutting board 160 in a sliding engagement such that first cutting board arm 168 may be slidingly engaged with first slot 161 and second cutting board arm 169 may be slidingly engaged with second slot 163 when first cutting board arm 168 is in alignment with first slot 161 and second cutting board arm 169 is in alignment with second slot 163, and cutting board 160 is motivated towards base mounting block 140 as indicated by the arrows in FIG. 6. The depths of slots 161 and 163 are dimensioned to retain cutting board 160. An optional first spring-loaded plunger 164 may be contained in first cutting board arm recess 166 and a second spring-loaded plunger 157 may be located in second cutting board arm recess 167, such that first spring loaded plunger 164 engages into first hole 165 located in first slot 161 and second spring loaded plunger engages in second hole 158 located in second slot 163 as cutting board 160 is slidingly engaged in first slot 161 and second slot 163 on either side of base mounting block 140. Cutting board 160 may also include an optional hinged cutting board extension 170 which is hingedly attached to cutting board 160 by hinge element 180 and may be rotated into an open position. Hinged cutting board extension 170 is depicted in the process opening in FIG. 7 by operation of hinge element 180. In FIG. 6, hinged cutting board extension 170 is depicted in a closed position, where a surface of hinged cutting board extension 170 rests upon a surface of cutting board 160 as shown. Opening 125, which provides a passageway through base mounting block 140 to allow a strap to pass through for securing to receiving structures of various configurations in alternate positions, is also depicted. Fishing pole holder 100, including fishing pole holder mount 121, and third slot 162 are shown for reference.

As used in this disclosure, “spring loaded plunger” or “spring loaded ball retainer” means a spring loaded device such as that known as a spring plunger or a ball plunger manufactured by Jergens Inc. of Cleveland, Ohio, which comprises a cylindrical body having an internal cavity containing a spring, which operates to press on a ball, cylinder with an external spherical end surface or similar structure in a direction such that the external spherical end surface of the ball or similar structure protrudes beyond the end of the cylindrical body in its natural extended state, but may be pressed and motivated inward towards the cylindrical body when a force is applied against the spring loaded ball or similar external spherical end surface in a direction oriented towards the cavity. “Spring loaded plunger” means any similar structure as hereinbefore described that has a substantially spherical spring loaded surface that may be depressed by the force described, and which returns to its original extended position with the force is removed. The external surface of the spring loaded plunger may comprise male threads for installation into a female threaded hole in a receiving body or may be a smooth cylindrical surface or other shape surface for press fit into a receiving body.

Referring now to FIG. 7, an alternate embodiment of the invention is shown in which first cutting board arm 168 of cutting board 160 is slidingly engaged with first slot 161 and second cutting board arm 169 is slidingly engaged with second slot 163. First slot 161 is located in right side surface 192 of base mounting block 140, and second slot 163 is located in left side surface 193 of base mounting block 140. Hinged cutting board extension 170 is hingedly engaged with cutting board 160 as depicted in the figure. Hinge element 180, which may be any type of hinge known in the mechanical arts such as, for example and not by way of limitation, a piano hinge or other similar hinge, may be attached to an edge of cutting board 160 and also attached to an edge of hinged cutting board extension 170 as shown such that hinged cutting board extension 170 may be rotated into an open position in which hinged cutting board extension 170 is coplanar with cutting board 160, forming an essentially unitary planar surface for preparing bait, cutting fish and the like. Cutting board 160 may be releasably retained onto mounting block 140 by operation of spring loaded plungers 157 and 164 (not shown in FIG. 7). When cutting board 160 is motivated towards base mounting block 140 such that first cutting board arm 168 of cutting board 160 is slidingly engaged with first slot 161 and second cutting board arm 169 is slidingly engaged with second slot 163, first spring loaded plunger 164 is engaged with and captured by first hole 165 located in first slot 161, and second spring loaded plunger 157 is engaged with and captured by second hole 158 located in second slot 163.

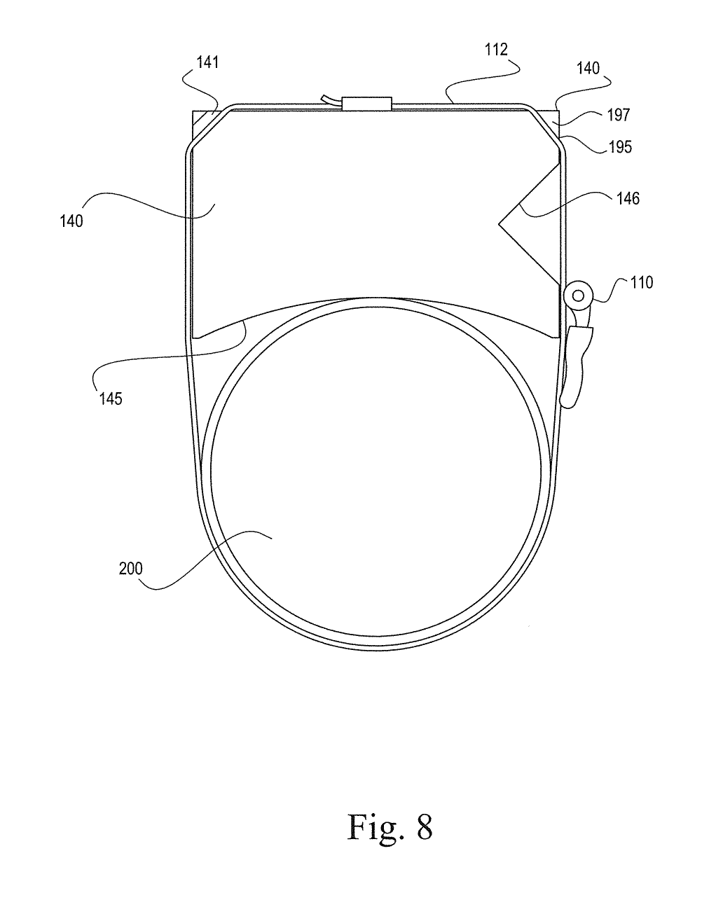

Referring now to FIG. 8, a cross section view of a preferred embodiment of the base mounting block 140 is shown mounted onto a horizontal receiving structure 200. Base mounting block arcurate surface 145 rests upon horizontal receiving structure 200 and is held firmly in place by operation of first strap 112 as tightened by first strap tightener 110, which may be any type of strap tightener known in the art such as ratcheting strap tighteners, cam action strap tighteners or any other type of strap tightener known in the art. Strap 112 passes through first receiving slot 141, around horizontal receiving structure 200, and over top rear chamfer 197. Once tightened, first strap 112 holds base mounting block 140 firmly in place against horizontal receiving structure 200, allowing a fisherman to insert a fishing rod into a fishing rod holder (not shown in FIG. 8) attached to a surface of base mounting block 140. In this manner the fisherman may utilize his hands for purposes other than holding the fishing rod. Base mounting block v-groove 146, which is located in base mounting block rear surface 195, is also depicted in FIG. 8. While this view depicts the operation of first strap 112 and first strap tightener 110, it is understood that second strap 113 and second strap tightener 111 may operate in like manner.

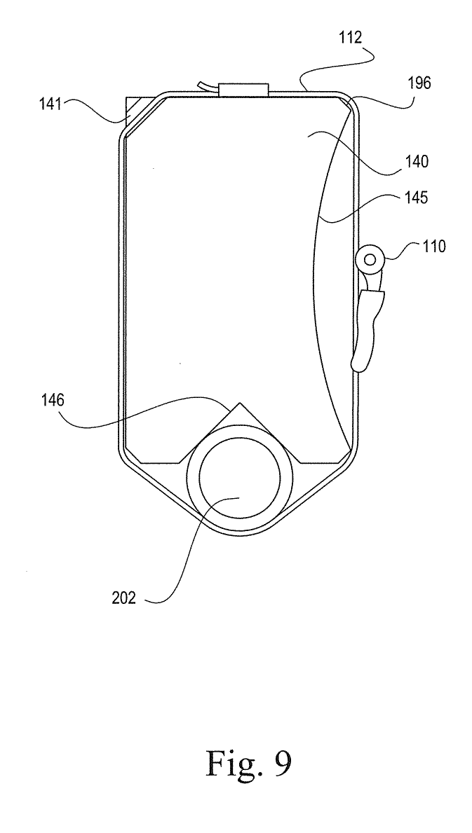

Referring now to FIG. 9, a cross section view of a preferred embodiment of the base mounting block 140 is shown mounted onto a horizontal receiving structure of smaller diameter 202. Base mounting block v-groove 146, which is preferably formed as a 90 degree “v” shape, but may be any angle, rests upon small diameter receiving structure 202 and is held firmly in place by operation of first strap 112 as tightened by first strap tightener 110, which may be any type of strap tightener known in the art such as ratcheting strap tighteners, cam action strap tighteners or any other type of strap tightener known in the art. Strap 112 passes through first receiving slot 141, around horizontal receiving structure 200, and over bottom rear chamfer 196. Once tightened, first strap 112 holds base mounting block 140 firmly in place against horizontal receiving structure 202, allowing a fisherman to insert a fishing rod into a fishing rod holder (not shown in FIG. 9) attached to a surface of base mounting block 140. In this manner the fisherman may utilize his hands for purposes other than holding the fishing rod. Base mounting block arcurate surface 145, which is located in base mounting block bottom surface, is depicted in FIG. 9. While this view depicts the operation of first strap 112 and first strap tightener 110, it is understood that second strap 113 and second strap tightener 111 may operate in like manner.

Referring now to FIG. 10, a cross section view of an alternate embodiment of the invention is shown, in which a cutting board 160 has been slidingly engaged with first slot 161 and second slot 163. First cutting board arm 168 comprises a first cutting board arm recess 166 (not shown in FIG. 10 but shown in FIG. 6), which further comprises first spring loaded plunger 164. First spring loaded plunger 164 engages first hole 165 located in first slot 161 when first cutting board arm 168 is aligned with first slot 161 and cutting board 160 is motivated towards base mounting block 140. First slot 161 comprises a width adapted to receive first cutting board arm 168 in a sliding engagement, and first slot 161 has a depth adapted to retain cutting board 160 when first cutting board arm 168 is in sliding engagement with first slot 161. First spring loaded plunger 164 engages with first hole 165 when first cutting board arm 168 is in sliding engagement with first slot 161, thus impeding further motivation of cutting board 160 once first spring loaded plunger 164 engages with first hole 165. The impediment to motivation of cutting board 160 by the engagement of first spring loaded plunger 164 with first hole 165 may be overcome by a user firmly grasping cutting board 160 and pulling it away from base mounting block 140. The impediment to motivation of cutting board 160 by the engagement of first spring loaded plunger 164 with first hole 165 operates to releasably retain cutting board 160 in first slot 161. Likewise, second cutting board arm 169 comprises a second cutting board arm recess 167 (not shown in FIG. 10 but shown in FIG. 6), which further comprises second spring loaded plunger 157. Second spring loaded plunger 157 engages second hole 158 located in second slot 163 when second cutting board arm 169 is aligned with second slot 163 and cutting board 160 is motivated towards base mounting block 140. Second slot 163 comprises a width adapted to receive second cutting board arm 169 in a sliding engagement, and second slot 163 has a depth adapted to retain cutting board 160 when second cutting board arm 169 is in sliding engagement with second slot 163. Second spring loaded plunger 157 engages with second hole 158 when second cutting board arm 169 is in sliding engagement with second slot 163, thus impeding further motivation of cutting board 160 once second spring loaded plunger 157 engages with second hole 158. The impediment to motivation of cutting board 160 by the engagement of second spring loaded plunger 157 with second hole 158 may be overcome by a user firmly grasping cutting board 160 and pulling it away from base mounting block 140. The impediment to motivation of cutting board 160 by the engagement of second spring loaded plunger 157 with second hole 158 operates to releasably retain cutting board 160 in second slot 163.

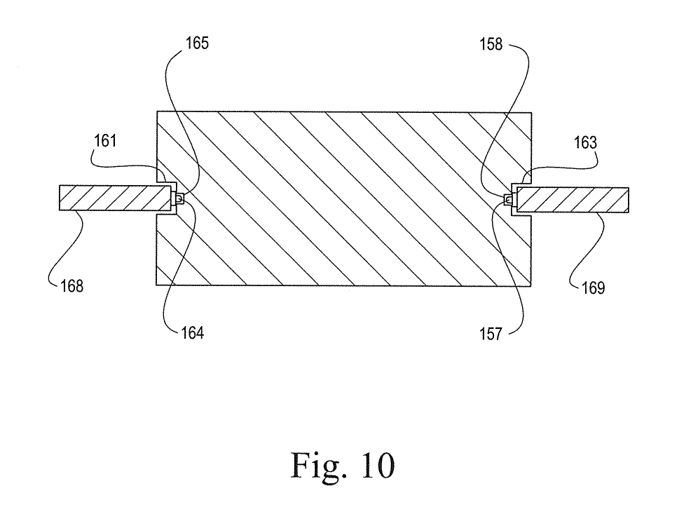

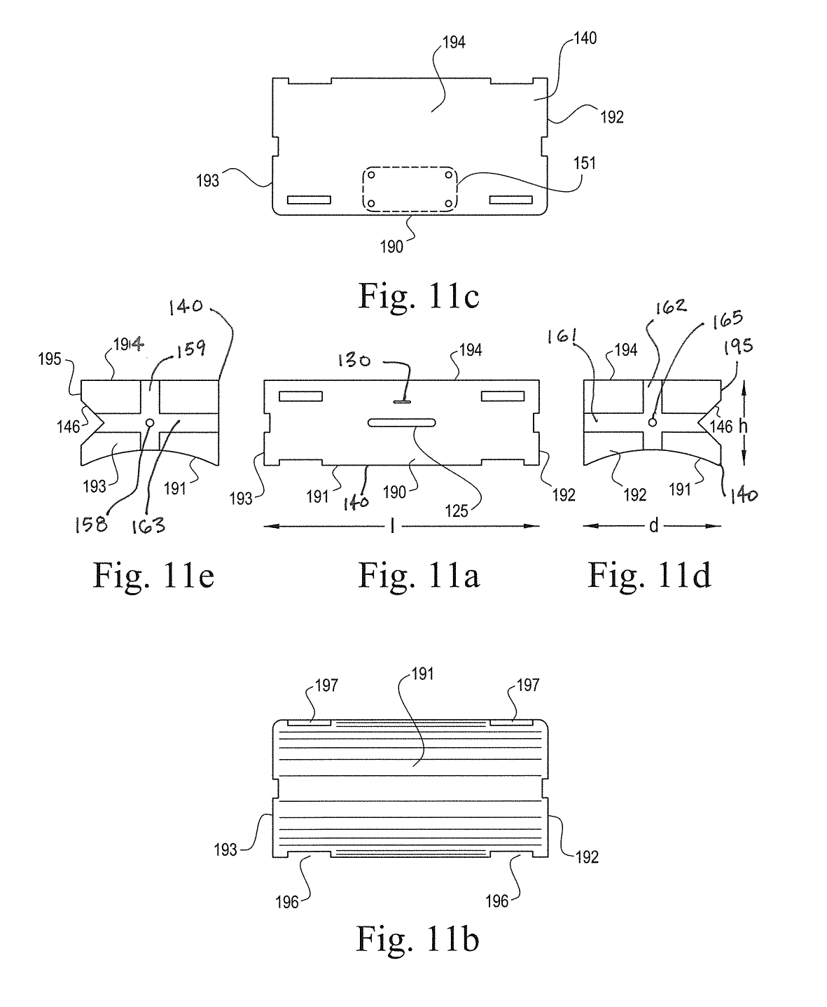

Referring now to FIGS. 11a through 11e, isometric views of the base mounting block 140 of a preferred embodiment of the invention are depicted. It is to be noted that the preferred embodiment depicted in FIGS. 11a-11e depict base mounting block as a substantially rectangular solid, but that other shapes are possible and are within the scope of the invention. Base mounting block 140 has a length l as shown in FIG. 11a, a depth d as shown in FIG. 11d, and a height h as shown in FIG. 11d. The length, width and height of base mounting block 140 are shown for orientation purposes and for clarity in the description and the claims.

Referring now to FIG. 11a, a front view of base mounting block 140, showing front surface 190 is shown. Top surface 194, right side surface 192, left side surface 193 and bottom surface 191 are identified. Opening 125, which creates a passageway passing through base mounting block 140 from front surface 190 to rear surface 195 (not shown in FIG. 11a) is depicted. Retaining eye 130 is also depicted. Opening 125 extends through base mounting block 140 to provide an alternative means for passing a strap through the base mounting block in order to attach the invention to various structures. This may be done as an alternative to using straps 112 and 113. The use of a strap in conjunction with opening 125 is an alternate embodiment of the invention that greatly increases the adaptability of the invention to certain structures, for example those structures which may not lend themselves easily to use of straps 112 and 113.

Referring now to FIG. 11b, a bottom isometric view of the base mounting block of a preferred embodiment of the invention is depicted. Bottom surface 191, which may comprise an arcurate surface for enabling a more secure mounting to a tubular receiving structure, is depicted. Right side surface 192 and left side surface 193 are indicated for clarity. Bottom rear chamfers 196 and top rear chamfers 197, which allow for easy passage and retention of tightening straps, may be present in base mounting block 140.

Referring now to FIG. 11c, a top isometric view of the base mounting block of a preferred embodiment of the invention is depicted. Top surface 194 is indicated. Front surface 190 and left side surface 193 are also indicated for clarity. Top surface 194 of base mounting block 140 may also comprise at least one, but preferably a plurality, of holes 151, which may be threaded to receive threaded fasteners for attaching a fishing pole holder to base mounting block 140.

Referring now to FIG. 11d, a right side isometric view of the base mounting block of a preferred embodiment of the invention is depicted. Right side surface 192 is indicated. Top surface 194 and bottom surface 191 are indicated for clarity. V-groove 146, which runs lengthwise in rear surface 195, is depicted. First hole 165, which is adapted to receive the ball of first spring loaded plunger 164 (not shown in FIG. 11d) may be located at the juncture of first slot 161 and third slot 162. Bottom surface 191 may be an arcurate surface to facilitate mounting the invention onto a tubular receiving structure.

Referring now to FIG. 11e, a left side isometric view of the base mounting block 140 of a preferred embodiment of the invention is depicted. Left side surface 193 is indicated. Top surface 194 and bottom surface 191 are indicated for clarity. Second hole 158 which is adapted to receive the ball of second spring loaded plunger 157 (not shown in FIG. 11e) may be located at the juncture of second slot 163 and fourth slot 159. V-groove 146, which runs lengthwise in rear surface 195, is depicted. Bottom surface 191 may be an arcurate surface to facilitate mounting the invention onto a tubular receiving structure.

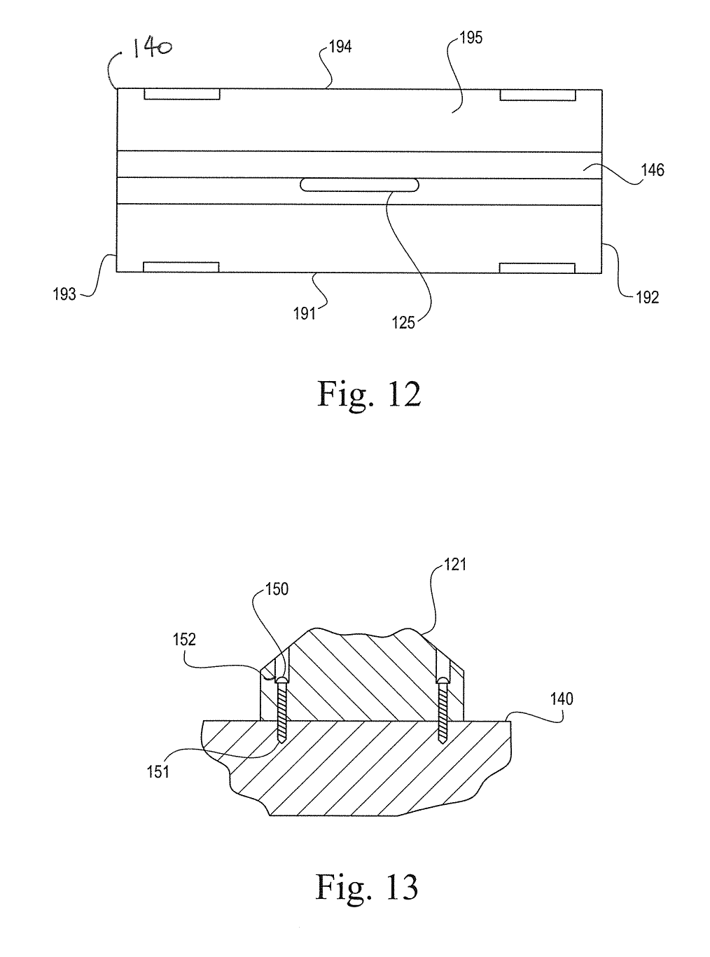

Referring now to FIG. 12, a rear view of the base mounting block 140 of a preferred embodiment of the invention is depicted. Right side surface 192 and left side surface 193 are indicated. Top surface 194 and bottom surface 191 are also shown for reference. Opening 125 extends through base mounting block 140 from front surface 190 (not shown in FIG. 12) to rear surface 195 to provide an alternative means for passing a strap through the base mounting block in order to attach the invention to various structures. V-groove 146, which runs lengthwise in rear surface 195, is depicted.

Referring now to FIG. 13, a cross section is shown in which fishing pole holder mount 121 is depicted as attached to top surface 194 of base mounting block 140 by use of at least one threaded fastener 150 which, in this preferred embodiment, resides in at least one counterbored through hole 152 in fishing pole holder mount 121, and is threadingly engaged with threaded hole 151 in top surface 194 of base mounting block 140. In a preferred embodiment a plurality of threaded fasteners 151 are located in matching plurality of counterbored through holes 152, and are threadingly engaged in a matching plurality of threaded holes 151.

Referring now to FIG. 14, an alternate embodiment of the invention is shown in which first cutting board arm 168 of cutting board 160 is slidingly engaged with first slot 161 and second cutting board arm 169 is slidingly engaged with second slot 163 (not shown in FIG. 14). First slot 161 is located in right side surface 192 of base mounting block 140, and second slot 163 is located in left side surface 193 of base mounting block 140. Counterbored through holes 152 are also for reference.

Although a detailed description as provided in the attachments contain many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. A pole holding apparatus mounting block, comprising:
a substantially solid rectangular block, having a length, width and height, and having a front surface, a rear surface, a left side surface, a right side surface, a top surface and a bottom surface;
wherein said front surface comprises at least one receiving slot adapted to accept a tightening strap, said receiving slot creating a passage between said front surface and said top surface;
wherein said top surface comprises at least one threaded hole located in said top surface, said at least one threaded hole adapted to accept threaded fasteners for mounting a fishing rod mount;
wherein said rear surface comprises a v-groove oriented lengthwise in said rear surface, and wherein said rear surface further comprises at least one bottom rear chamfer adapted to receive a tightening strap, said chamfer creating a joining surface between said rear surface and said bottom surface; and
wherein said rear surface further comprises at least one top rear chamfer adapted to receive a tightening strap, said chamfer creating a joining surface between said rear surface and said top surface.

2. The pole holding apparatus mounting block of claim 1, further comprising an opening passing through said substantially solid rectangular solid, said opening entering said front surface and exiting said rear surface and creating a passageway from said front surface through said rectangular solid and exiting said rear surface.

3. The pole holding apparatus mounting block of claim 1, further comprising at least one tightening strap for securing said mounting block onto a structure.

4. The pole holding apparatus mounting block of claim 3, wherein said at least one tightening strap comprises a tightening element selected from the group consisting of ratcheting tightener and a cam action tightener.

5. The pole holding apparatus mounting block of claim 1, further comprising:
an opening passing through said substantially solid rectangular solid, said opening entering said front surface and exiting said rear surface and creating a passageway from said front surface through said rectangular solid and exiting said rear surface; and
at least one tightening strap for securing said mounting block onto a structure.

6. The pole holding apparatus mounting block of claim 5, wherein said at least one strap comprises a tightening element selected from the group consisting of ratcheting tightener and a cam action tightener.

7. The pole holding apparatus mounting block of claim 1,
wherein said left side of substantially rectangular solid block further comprises a first slot running in the direction of the width of said substantially rectangular solid block, said slot having a width and depth; and
wherein said right side of substantially rectangular solid block further comprises a second slot running in the direction of the width of said substantially rectangular solid block, said slot having a width and depth; and
a planar cutting board having a thickness a first arm and a second arm, said first arm adapted to slidingly engage with said first slot and said second arm adapted to slidingly engage with said second slot when said cutting board first and second arms are oriented in alignment with said first slot and said second slot and said cutting board is motivated towards said mounting block;
wherein said first slot width and said second slot width are adapted to receive said cutting board thickness in a sliding engagement and wherein said first slot depth and said second slot depth are adapted to retain said cutting board when said cutting board is slidingly engaged with said first slot and said second slot.

8. The pole holding apparatus mounting block of claim 7, further comprising an opening passing through said substantially solid rectangular solid, said opening entering said front surface and exiting said rear surface and creating a passageway from said front surface through said rectangular solid and exiting said rear surface.

9. The pole holding apparatus mounting block of claim 7, further comprising at least one tightening strap for securing said mounting block onto a structure.

10. The pole holding apparatus mounting block of claim 9, wherein said at least one tightening strap comprises a tightening element selected from the group consisting of ratcheting tightener and a cam action tightener.

11. The pole holding apparatus mounting block of claim 7, further comprising:
an opening passing through said substantially solid rectangular solid, said opening entering said front surface and exiting said rear surface and creating a passageway from said front surface through said rectangular solid and exiting said rear surface; and
at least one tightening strap for securing said mounting block onto a structure.

12. The pole holding apparatus mounting block of claim 11, wherein said at least one tightening strap comprises a tightening element selected from the group consisting of ratcheting tightener and a cam action tightener.

13. The pole holding apparatus mounting block of claim 7,
wherein said left side of substantially rectangular solid block further comprises a third slot running in the direction of the depth of said substantially rectangular solid block, said slot having a width and depth; and
wherein said right side of substantially rectangular solid block further comprises a fourth slot running in the direction of the depth of said substantially rectangular solid block, said slot having a width and depth;
said first arm adapted to slidingly engage with said third slot and said second arm adapted to slidingly engage with said fourth slot when said cutting board first and second arms are oriented in alignment with said third slot and said fourth slot and said cutting board is motivated towards said mounting block;
wherein said third slot width and said fourth slot width are adapted to receive said cutting board thickness in a sliding engagement and wherein said third slot depth and said fourth slot depth are adapted to retain said cutting board when said cutting board is slidingly engaged with said third slot and fourth second slot.

14. The pole holding apparatus mounting block of claim 13, further comprising an opening passing through said substantially solid rectangular solid, said opening entering said front surface and exiting said rear surface and creating a passageway from said front surface through said rectangular solid and exiting said rear surface.

15. The pole holding apparatus mounting block of claim 13, further comprising at least one tightening strap for securing said mounting block onto a structure.

16. The pole holding apparatus mounting block of claim 15, wherein said at least one tightening strap comprises a tightening element selected from the group consisting of ratcheting tightener and a cam action tightener.

17. The pole holding apparatus mounting block of claim 13, further comprising:
an opening passing through said substantially solid rectangular solid, said opening entering said front surface and exiting said rear surface and creating a passageway from said front surface through said rectangular solid and exiting said rear surface; and
at least one tightening strap for securing said mounting block onto a structure.

18. The pole holding apparatus mounting block of claim 17, wherein said at least one tightening strap comprises a tightening element selected from the group consisting of ratcheting tightener and a cam action tightener.

19. The pole holding apparatus mounting block of claim 12,
wherein said first slot further comprises a first hole having a diameter located in said first slot and a second hole having a second diameter located in said second slot; and
wherein said first arm further comprises a first recess having a first spring-loaded plunger therein and said second arm further comprises a second recess having a second spring-loaded plunger therein,
wherein said first hole diameter is adapted to receive said first spring-loaded plunger such that further sliding of said first arm in said first slot is impeded and said second hole diameter is adapted to receive said second spring-loaded plunger such that further sliding of said second arm in said second slot is impeded;
such that when said first arm is in alignment with said first slot and said second arm is in alignment with said second slot, and cutting board is motivated towards said mounting block such that said first arm is in sliding engagement with said first slot and said second arm is in sliding engagement with said second slot, said spring loaded ball of said first spring-loaded plunger engages with said first hole and said spring loaded ball of said second spring-loaded plunger engages with said second hole, impeding further motivation of said cutting board.

20. The pole holding apparatus mounting block of claim 18,
wherein said third slot further comprises a first hole having a first diameter located in said third slot and a second hole having a second diameter located in said fourth slot; and
wherein said first arm further comprises a recess having a first spring-loaded plunger therein and said second arm further comprises a recess having a second spring-loaded plunger therein,
wherein said first hole diameter is adapted to receive said first spring-loaded plunger such that further sliding of said first arm in said third slot is impeded and said second hole diameter is adapted to receive said second spring-loaded plunger such that further sliding of said second arm in said fourth slot is impeded;
such that when said first arm is in alignment with said third slot and said second arm is in alignment with said fourth slot, and said cutting board is motivated towards said mounting block such that said first arm is in sliding engagement with said third slot and said second arm is in sliding engagement with said fourth slot, said first spring loaded plunger engages with said first hole and said second spring loaded plunger engages with said second hole, impeding further motivation of said cutting board.

21. The pole holding apparatus mounting block of claim 19, further comprising:
a hinged cutting board, wherein said hinged cutting board is hingedly attached to said cutting board.

22. The pole holding apparatus mounting block of claim 20, further comprising:
a hinged cutting board, wherein said hinged cutting board is hingedly attached to said cutting board.

23. The pole holding apparatus mounting block of claim 19, further comprising a fishing pole holder attached to said top surface of said base mounting block by at least one threaded fastener.

24. The pole holding apparatus mounting block of claim 20, further comprising a fishing pole holder attached to said top surface of said base mounting block by at least one threaded fastener.

25. The pole holding apparatus mounting block of claim 21, further comprising a fishing pole holder attached to said top surface of said base mounting block by at least one threaded fastener.

26. The pole holding apparatus mounting block of claim 22, further comprising a fishing pole holder attached to said top surface of said base mounting block by at least one threaded fastener.
